(19) United States
(12) Patent Application Publication
(10) Pub. No.: US 2011/0231654 A1
(43) Pub. Date: Sep. 22, 2011

(54) METHOD, SYSTEM AND APPARATUS PROVIDING SECURE INFRASTRUCTURE

(76) Inventors: Gurudas Somadder, San Jose, CA (US); Joël R. Calippe, San Jose, CA (US); Paula N. Balus, Cupertino, CA (US); Sergio Colla, San Jose, CA (US); Mohammad Farook, Sunnyvale, CA (US)

(21) Appl. No.: 13/047,859

(22) Filed: Mar. 15, 2011

Related U.S. Application Data
(60) Provisional application No. 61/314,448, filed on Mar. 16, 2010.

(51) Int. Cl. H04L 29/06

(52) U.S. Cl. 713/153

(57) ABSTRACT

Methods and apparatus for automatically providing secure network infrastructure over non-secure network infrastructure such as by automatically generating IPSec tunnels through non-secure networks, terminating the IPSec tunnels at a boundary device and creating appropriate services to bridge traffic between the IPSec tunnels and a secure network. Various embodiments provide rapid provisioning of secure network infrastructure, a Secure Gateway (SEG) embodiment adapted to particular customer requirements and various business methodologies.

### CROSS REFERENCE TO RELATED APPLICATION

This application claims the benefit of U.S. Patent Application Ser. No. 61/314,448, filed on Mar. 16, 2010, entitled METHOD, SYSTEM AND APPARATUS FOR IPSEC INFRASTRUCTURE PROVISIONING, MANAGEMENT AND APPLICATIONS THEREOF, which application is incorporated herein by reference in its entirety.

### FIELD OF THE INVENTION

The invention relates generally to communication networks and, more specifically but not exclusively, to provisioning secure services over a non-secure transport layer.

### BACKGROUND

Various networks such as Fourth Generation (4G) wireless networks support large numbers of wireless subscribers running one or more applications. Traffic is packetized and transported via IP networks according to multiple network elements utilizing different transport technologies, applied quality-of-service (QoS) policies and so on. Such networks are inherently complex and present new challenges to network service providers and the network management tools they rely upon to ensure consistent delivery of high-quality services to their mobile subscribers.

Provisioning and monitoring a secure infrastructure layer such as IPSec infrastructure layer in conjunction with the transport layer upon which it is built is complex and prone to error. Transport networks are initially provisioned to support the bandwidth deemed necessary for various customer goals. An IPSec infrastructure is then built on top of the provisioned network as secure networking is needed.

The transport network provisioning process and IPSec infrastructure provisioning process are independent of each other. This independence leads to inefficiency and lack of mutual awareness between these two layers, which causes problems during troubleshooting, updating, network management and other functions. For example, any failure within transport network elements below the IPSec layer will impact the functionality of the IPSec layer, such as by degrading Virtual Private Remote Networking (VPRN) of an end subscriber or end consumer.

### SUMMARY

Various deficiencies in the prior art are addressed by embodiments for providing secure network infrastructure over non-secure network infrastructure. Various embodiments provide rapid provisioning of secure network infrastructure, a Secure Gateway (SEG) embodiment adapted to particular customer requirements, various business methodologies and the like.

Various embodiments operate to configure elements within an existing non-secure network environment to enable the services necessary to support secure tunneling between access points for users accessing a secure network via a non-secure network, such as Level 3 (L3) Virtual Private Networking (VPN) services, VPRN (Virtual Private Routed Network) service, IES (Internet Enhanced Service) service and/or other services. When configured, the secure network (e.g., a corporate network) is protected with respect to users accessing the corporate network through non-secure networks such as the Internet (e.g., IPSec connections to corporate or other secure networks).

In a Secure Gateway (SEG) embodiment, a router associated with a boundary device operates as a secure client to a secure network, while various users operate as secure clients to the router. In this manner, IPSec traffic associated with the users is terminated at the boundary device of the Secure Gateway rather than at a termination point associated with the secure network. By avoiding the termination of multiple user IPSec tunnels within the secure network, the security of the network is enhanced, the provisioning complexity is reduced, and the corporate network may retain existing services and protocols (e.g., L2 VPN).

### BRIEF DESCRIPTION OF THE DRAWINGS

The teachings of the present invention can be readily understood by considering the following detailed description in conjunction with the accompanying drawings, in which:

FIG. 1 depicts an exemplary architecture according to one embodiment;

FIG. 2 depicts a more detailed view of network protocols proximate a boundary card within a router in the architecture of FIG. 1;

FIG. 3 depicts a high-level block diagram illustrating a service creation and correlation process performed by the exemplary management system of FIG. 2;

FIG. 4 depicts a high-level block diagram of a wholesale video service architecture;

FIG. 5 depicts an exemplary management system suitable for use in the various embodiments;

FIG. 6 depicts an exemplary wireless communication system including a management system according to an embodiment; and

FIGS. 7-8 depict high-level block diagrams illustrating a discovery and correlation process performed by a management system according to various embodiments.

To facilitate understanding, identical reference numerals have been used, where possible, to designate identical elements that are common to the figures.

### DESCRIPTION

The invention will be primarily described within the context of particular embodiments, however, those skilled in the art and informed by the teachings herein will realize that the invention is also applicable to other technical areas and/or embodiments.

Generally speaking, the various embodiments enable, support and/or improve the provisioning and monitoring associated with building a secure infrastructure layer (e.g., an IPSec infrastructure layer) on top of a provisioned network transport layer to provide secure networking services as such services are needed.

Various embodiments are also applicable within the context of Secure Sockets Layer (SSL) Virtual Private Network (VPN), Dynamic Multipoint VPN, Opportunistic Encryption and the like. Various embodiments benefiting from such services will also be discussed, including access to a secure corporate network via one or more non-secure core and/or access networks, providing video on demand (VOD) and other television/broadcasting services and the like.

The various embodiments are suitable for use in any access or core network environment supporting secure networking techniques such as IPSec tunneling, including existing and future wireline and/or wireless IP networks or networks used IP-type control protocols. For example, various systems, apparatus, methodologies, functions, programs, topologies and so on described herein with respect to long term evolution (LTE) related environments (typically accessed via eNodeBs) are also applicable to other environments, such as those accessed via digital subscriber lines (DSLs), cable modems and other existing and future access technologies. It is also contemplated by the inventors that other various LTE components may also use secure tunnels in accordance with the invention, such as the MME, SGW, PCRF (DSC) and/or PGW. Generally speaking, any component of an LTE network or other network may benefit from having a secured tunnel through the Security Gateway (SEG). Although it is true that it is the eNodeB that will be the most common client of this functionality.

Various embodiments operate to configure elements within an existing non-secure network environment to enable the services necessary to support secure tunneling between access points for users accessing a secure network via a non-secure network, such as Level 3 (L3) Virtual Private Networking (VPN) services, VPRN (Virtual Private Routed Network) service such as 2547bis, IES (Internet Enhanced Service) service and/or other services. When configured, the secure network (e.g., a corporate network) is protected with respect to users accessing the corporate network through non-secure networks such as the Internet (e.g., IPSec connections to corporate or other secure networks).

In a Secure Gateway (SEG) embodiment, a router associated with a boundary device operates as a secure client to a secure network, while various users operate as secure clients to the router. In this manner, IPSec traffic associated with the users is terminated at the boundary device of the Secure Gateway rather than at a termination point associated with the secure network. By avoiding the termination of multiple user IPSec tunnels within the secure network, the security of the network is enhanced, the provisioning complexity is reduced, and the corporate network may retain existing services and protocols (e.g., L2 VPN).

### Providing a Secure Infrastructure Layer

Generally speaking, the various embodiments enable, support and/or improve the provisioning and monitoring associated with building a secure infrastructure layer such as IPSec infrastructure layer on top of a provisioned network transport layer to provide secure networking services as such services are needed, such as providing access to a secure corporate network via one or more non-secure core and/or access networks.

The various embodiments described herein are suitable for use in any access or core network environment supporting secure networking techniques such as IPSec tunneling, including existing and future wireline and/or wireless IP networks or networks use IP-type control protocols. For example, various systems, apparatus, methodologies, functions, programs, topologies and so on described herein with respect to long term evolution (LTE) related environments (accessed via eNodeBs) are also applicable to other environments, such as those accessed via digital subscriber lines (DSLs), cable modems and other existing and future access technologies.

Various embodiments operate to configure elements within an existing non-secure network environment to enable the services necessary to support secure tunneling between access points for users accessing a secure network via a non-secure network, such as Level 3 (L3) Virtual Private Networking (VPN) services, VPRN (Virtual Private Routed Network) service, IES (Internet Enhanced Service) service and/or other services. When configured, the secure network (e.g., a corporate network) is protected with respect to users accessing the corporate network through non-secure networks such as the Internet (e.g., IPSec connections to corporate or other secure networks).

In a Secure Gateway (SEG) embodiment, a router associated with a boundary device operates as a secure client to a secure network, while various users operate as secure clients to the router. In this manner, IPSec traffic associated with the users is terminated at the boundary device of the Secure Gateway rather than at a termination point associated with the secure network. By avoiding the termination of multiple user IPSec tunnels within the secure network, the security of the network is enhanced, the provisioning complexity is reduced, and the corporate network may retain existing services and protocols (e.g., L2 VPN).

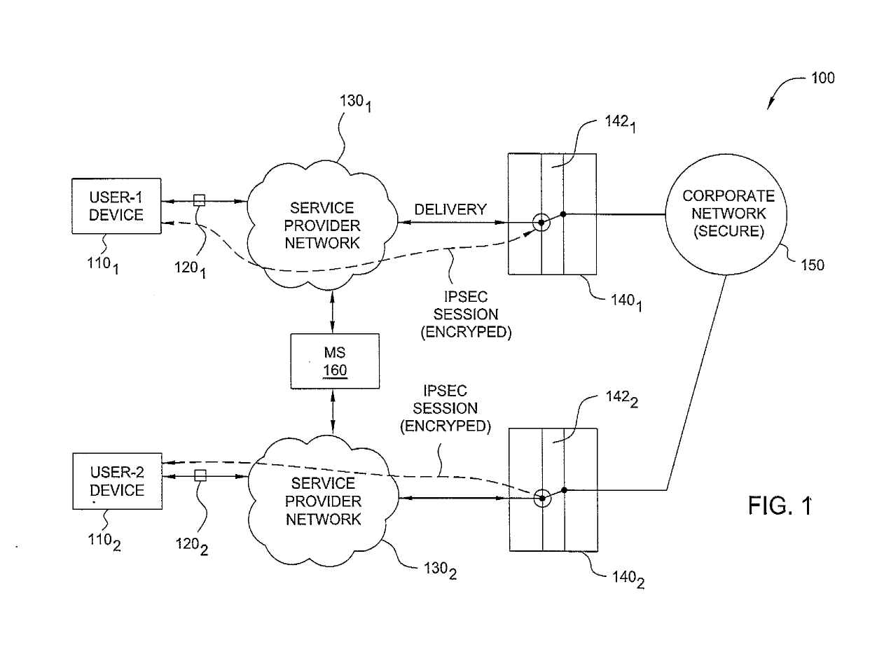

FIG. 1 depicts a simplified architecture according to one embodiment. Specifically, simplified architecture 100 of FIG. 1 represents a portion of a larger network (not shown) in which two users communicate with each other via respective secure paths through non-secure networks, each secure path initiated at an access point of a non-secured network and terminating at a secure corporate network which operates to connect the users to form thereby a secure path between the users.

Referring to FIG. 1, a first user 1101 accesses a first non-secure network 8301 via a respective access device 1201, and a second user 1102 accesses a second non-secure network 1302 via a respective access device 1202. Traffic is transported between the first access device 1201 and a first routing device 1401 by one or more links/paths within the first non-secure network 8301, and between the second user 1102 and a second routing device 1402 by one or more links/paths within the second non-secure network 8302.

Depending upon the type of non-secure network 130 to be accessed by a user device 110, the corresponding access devices 120 may comprise digital subscriber line (DSL), cable modem, eNodeB or other access devices or aggregation points.

Each of the routing devices 140 includes or is associated with a boundary device 142 or similar termination/bridging mechanism to terminate traffic from the non-secure network 130, terminate traffic from a secure network 140, and bridge the terminated traffic between the non-secure 130 and secure 140 networks as appropriate.

The routing device 140 may comprise any router or switching device or combination thereof capable of providing the routing, bridging and/or other functions described herein. In one embodiment, the routing device 140 comprises an Alcatel-Lucent 7750 service router having installed therein an IPSec boundary card 142.

Thus, in one embodiment, each of the user devices communicates via a link between a respective access device 120 and the non-secure side of, for example, a respective IPSec boundary card in a respective router. The secure network sides of the IPSec boundary card communicate with each other via the secure corporate network.

Packets traveling within the secure network do not need IPSec tunneling to travel there through. Generally speaking, the secure corporate network utilizes L3 VPN or other secure infrastructure to transport traffic so that further encryption of such traffic within the corporate network is unnecessary (in fact, further encryption might render the encrypted packets unreadable).

Packets traveling through the non-secure network are conveyed via an IPSec session (encrypted) which is supported by various transport layer hardware, software, protocols and the like.

The boundary device 142 is used to create/terminate a secure (encrypted) service through the non-secure network using L3 VPN, VPRN and the like. That is, a secure IPSec session is created between the user device (having its own respective IP address) and the boundary device (which also has its own respective IP address). In this manner, the boundary device communicates packets from the secure (encrypted) service provided via the non-secure network to the secure corporate network for propagation to, illustratively, users within the secure corporate network or users outside of the secure corporate network (e.g., the second user of FIG. 1).

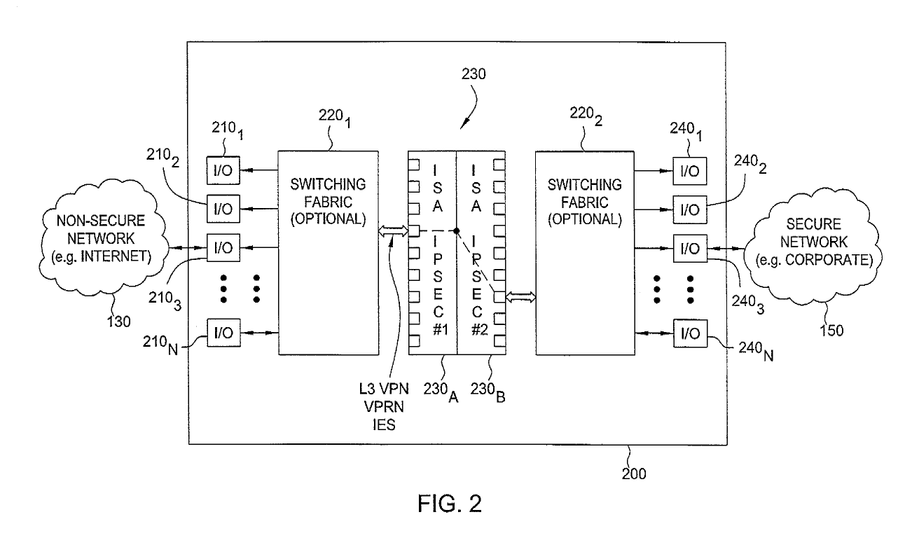

Optionally, the boundary device also supports Internet Enhanced Service (IES) for the secure IPSec session. The boundary device 142 will be described in more detail below with respect to FIG. 2.

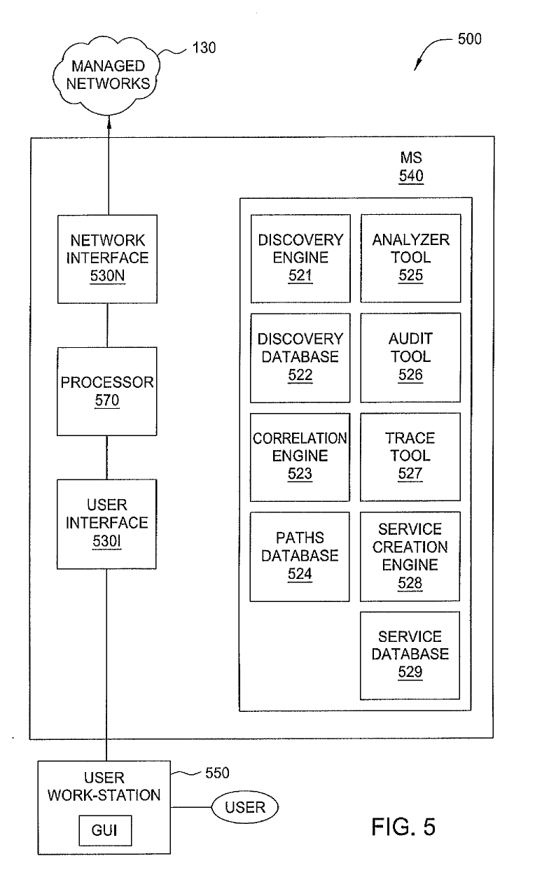

FIG. 1 also depicts a management system (MS) 170 that provides management functions for managing the non-secure network 130. The MS 170 may communicate with non-secure network 130 in any suitable manner. An exemplary management system suitable for use as MS 170 of FIG. 1 is depicted below and described with respect to FIG. 5.

In FIG. 1, the dashed lines represent the path of an encrypted IPSec session. It is noted that both of the first and second users are associated with a respective encrypted IPSec session terminating at respective routing devices 140. The boundary device optionally strips off encryption from packets before passing them to the secure network since the packets may otherwise become unintelligible.

While FIG. 1 depicts only two users, it will be appreciated that more than two users may be in communication with each other and that each user may be in communication with more than one other user.

While FIG. 1 depicts each user 110 accessing a respective non-secure network 130 via a respective access device 120, the users may in fact be accessing a common non-secure network by respective or common access devices. Moreover, a user may access multiple non-secure networks simultaneously, such as a mobile device user accessing a 3G/4G/xG network and a local 802.11x network or hot spot.

While FIG. 1 depicts a single non-secure network between a user 110 and routing device 140, in various embodiments the user traffic will be transported via multiple non-secure networks, such as via an access network and a core network.

It should be noted that one or many users may be connected to the secure network via one or more routing devices 140 operating as, illustratively, Secure Gateways (SEGs). Moreover, in various embodiments one or more of the routing devices 140 may be accessible from multiple networks. For example, in various embodiments both of the unsecured networks 130 depicted herein with respect to FIG. 1 may access both of the routing devices 140. It may be the case that a particular unsecured network 130 will prefer a particular routing device 140 based upon cost considerations; however, the ability to access multiple routing devices 140 provides redundancy and/or resiliency within the context of the various embodiments.

In various embodiments, an Alcatel-Lucent versatile service module (VSM) is used to allow cross connection of services.

The above-described embodiments are supported by routing devices operating as Secure Gateways to the secure network 140. For example, a router including a boundary device (e.g., a 7750 router having multiple boundary cards, switching modules and the like) may be configured as a security gateway product which, when installed within a service provider network, provides and/or supports the various secure transport and management functions described herein.

FIG. 2 depicts an exemplary security gateway (SEG) according to one embodiment. Specifically, FIG. 2 depicts a security gateway 200 including a first plurality of input/output interfaces denoted as I/O interfaces 210, a switching fabric 220, a boundary device 230 and a second plurality of I/O interfaces 240.

When provisioned according to the various embodiments, the security gateway (SEG) 200 provides termination, routing and bridging functionality within the context of the various embodiments discussed herein. That is, encrypted user traffic is transported through a non-secure network 130 to/from the security gateway 200 via IPSec tunnels terminated at a first portion 230A of the boundary device 230. Unencrypted user traffic is transported through a secure network 150 to/from the security gateway 200 and terminated at a second portion 230B of the boundary device 230.

In the embodiment of FIG. 2, the first and second portions of the boundary device 230 comprise respective first 230A and second 230B boundary cards. In other embodiments, a single boundary card is used. In other embodiments, still other boundary device mechanisms are used.

For example, while FIG. 2 depicts the use of two boundary cards deployed in, illustratively, a HA and load-balancing mode, more or fewer boundary cards may be used within the context of the various embodiments. Specifically, a single boundary card is capable of connecting the non-secure network services to the secure network services. For example, both ingress and egress IPsec Interfaces may be on the same boundary device or boundary card since, in various embodiments, these IPsec Interfaces are virtual interfaces that merely provide the required functionality to support the IPSec service.

The first plurality of input/output interfaces is denoted as I/O interfaces 2101, 2102, 2103 and so on through 210N, where each of the I/O interfaces includes a plurality of ingress ports, egress ports, buffers and the like (not shown). Encrypted user traffic is communicated between the first plurality of I/O interfaces 210 and first portion 230A of the boundary device 230 via, illustratively, a first portion 2201 of the switching fabric 220.

The second plurality of input/output interfaces is denoted as I/O interfaces 2401, 2402, 2403 and so on through 240M, where each of the I/O interfaces includes a plurality of ingress ports, egress ports, buffers and the like (not shown). Unencrypted user traffic is communicated between the second plurality of I/O interfaces 210 and second portion 230B of the boundary device 230 via, illustratively, a second portion 2202 of the switching fabric 220.

In the embodiment of FIG. 2, the switching fabric 220 is depicted as including first and second portions for switching traffic between the boundary device 230 and, respectively, first plurality of input/output interfaces 210 and second plurality of input/output interfaces 220. The switching fabric 220 may be implemented without separate portions and/or omitted altogether. For example, in various embodiments a very few number of second plurality of input/output interfaces is used since the SEG 200 may be deployed to serve the needs of a very few number of secure networks (e.g., several corporate clients at a specific location).

To support encrypted user traffic via IPSec tunnels terminated at the first portion 230A of the boundary device 230, it is necessary for the boundary device to be configured to support those protocols enabling such IPSec tunneling, such as L3 VPN, IES, VPRN and the like as previously noted.

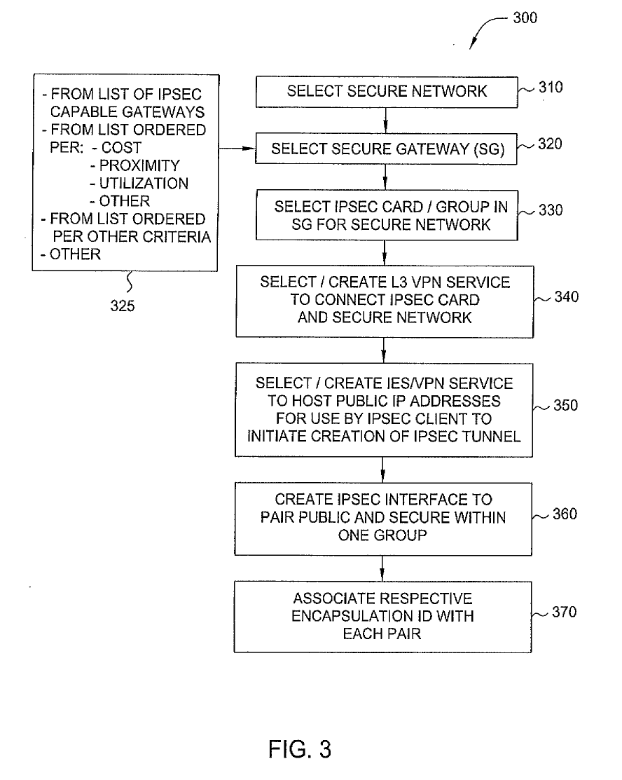

FIG. 3 depicts a flow diagram of a method for automatically provisioning secure transport infrastructure over non-secure transport infrastructure. The method 300 of FIG. 3 may be triggered in response to a service request or other indication of a need to provide a secure service to a customer (e.g., a corporate customer having a secure network in communication with a non-secure network of a service provider).

At step 310, a secure network is selected for protection. For example, referring to FIGS. 1 and 2, the secure network 150 may comprise a corporate network associated with a corporate customer of a service provider. In this case, the corporate customer wishes to give one or more users secure access to the corporate network, where the one or more users will be accessing via non-secure networks. The secure network to be protected may be included within a customer service request, profile information within a service request, entered directly by operations personnel and the like.

At step 320, a Secure Gateway (SEG) is selected. For example, referring to FIGS. 1 and 2, a routing device 140 proximate the corporate network 150 and having a boundary device 142 may be selected for provisioning as a Secure Gateway 200. Referring to box 325, the specific SEG selected for use may comprise one of a plurality of available IPSec-capable Gateway devices. The SEG may be automatically selected according to one or more of the following criteria: cost (e.g., lowest cost in terms of shortest path or other measure), proximity to customer, proximity to service provider, utilization level (available bandwidth or processing resources) and/or other criteria. Various other mechanisms for selecting a particular Gateway to be used as a Secure Gateway SEG may also be employed. In a NOC embodiment, a list of potential SGs may be visually presented to the operator in terms of the above criteria to assist in the selection.

At step 330, one or more boundary devices such as one or more IPSec cards or groups in the one or more SGs is selected for use in protecting the secure network. Multiple boundary devices may be used to provide redundancy, resiliency or otherwise handle large bandwidth traffic.

At step 340, a secure networking service such as a L3 VPN service is selected, created or otherwise provided to connect the selected boundary device (e.g., an IPSec card) and the secure network. The selected, created or otherwise provided service is associated with the portion of the boundary device 130 facing the secure network, such as the second portion 230B of boundary card 230. For example, if the secure network 150 is coupled to the selected gateway device via something other than a L3 VPN (e.g., an L2 VPN), then an appropriate L3 VPN service is created such that IPSec functionality/infrastructure may be connected to the secure network 150.

At step 350, a service such as an IES, VPN and/or VPRN service to host public IP addresses for use by secure clients such as IPSec clients is selected, created or otherwise provided. The public IP addresses hosted by the IES, VPN and/or VPRN service is used by IPSec clients to initiate the creation of IPSec tunnels. The selected, created or otherwise provided service is associated with the portion of the boundary device 130 facing the non-secure network, such as the first portion 230A of boundary card 230. For example, a user device 110 will need an address to use for terminating an IPSec tunnel, which address will be provided by the IES, VPN and/or VPRN service associated with the first portion of the boundary card.

At step 360, an IPSec interface is created to pair or associate within a single group the public traffic of the non-secure network and secure traffic associated with the network to be protected such that the secured network receives public traffic from appropriate users via the appropriate tunnel(s), and conveys traffic to appropriate users via the appropriate tunnel(s). The public traffic comprises traffic conveyed by IPSec tunnels terminated at the portion of the boundary device facing the non-secure network(s), while private traffic comprises traffic terminated at the portion of the boundary device facing the secure network. Those IPSec tunneled paths conveying traffic associated with the secure network are grouped with secure network traffic paths.

At step 370, each service pair is associated with a respective encapsulation identifier so that identified traffic associated with different service pairs (protected, distribution; secured, public) may be segregated. In this manner, the public/private paths are bridged via the boundary device to provide secure public access to appropriate or authorized users of the secure network.

In various embodiments, the groups operate to bundle boundary cards, which give the IPsec functionality to IPsec Interfaces that are created in the context of an IPsec group. In various embodiments, there are two IPsec Interfaces per groups, one public and one private. The encapsulation on the two interfaces must match for a binding of one Public L3VPN and a Private L3VPN. This encapsulation allows the assignment of several service bindings to a single IPsec Interface pair (e.g., such as providing a VLAN at a port to segregate the traffic from one network or user to another).

The method 300 of FIG. 3 provides a provisioning mechanism in which access to a secure network owned by a company or other customer of a service provider may be automatically provided by the service provider. In operation, many access points within a non-secure network may be authorized to access the secure network. Each of these access points will communicate traffic to and from any SEG via a secure tunnel. In various embodiments, multiple SGs may be used to protect the secure network. In these embodiments, each of the various access points will be associated with a particular SEG, and each SEG may be used to terminate one or more tunnels from the various access points.

In some embodiments, the particular SEG associated with a particular user is selected in accordance with the quality of service needs of the user, service level agreements associated with the user, type of traffic between the user and the secured network, specific access device of the user and so on. Some routers may be capable of providing a very high capacity/bandwidth SEG function, while other routers may be able to provide only modest capacity to protect the secure network. It is also contemplated in some embodiments that special-purpose routers having specific boundary device capability, bandwidth capability and the like are deployed proximate the secure networks of service provider customers such that rapid instantiation or construction of secure infrastructure may be rapidly provided as discussed herein.

In various embodiments, steps 340, 360 and/or 370 are automatically invoked based on resource availability, such as the presence of a particular service, the of encapsulation identifications or associations already in use, the boundary devices or sub-devices (e.g., IPsec Modules or cards) having excess capacity and so on. These steps may be automated via a service aware manager (SAM) such as described herein such that specific input from an operator is not necessary to create or provision the secure tunnels, the mechanism by which traffic flows between the secure tunnels and the protected network and so on.

### Content Provider Embodiments

In one embodiment, the content provider delivers content to users via secure IPSec paths at specific times of the day (e.g., Netflix replenishing the client DVR devices). The IPSec infrastructure supporting the necessary IPSec paths to supply content to users changes as the subscriber base changes. Periodically the content provider transmits service requests to the service creation engine (via the network management system), which requests result in the service creation engine adapting the IPSec infrastructure to accommodate the requested service, such as a request for additional IPSec path to stream content to users in specific geographic area.

### Television/Video/Video on Demand (VOD) Wholesale Embodiments

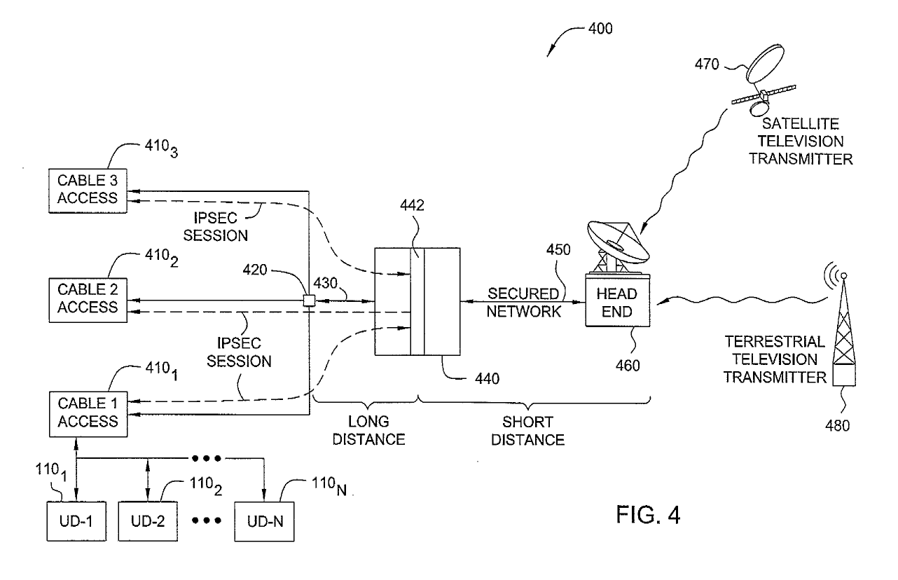

FIG. 4 depicts a high-level block diagram of a system for delivering television, video and/or VOD services to remote locations. Specifically, the system 400 of FIG. 4 provides a mechanism wherein relatively small markets which would otherwise not be served by the major content distribution companies (cable companies, telecom companies and the like) may receive such services via intermediary or wholesale companies.

Specifically, each of a plurality of cable access neighborhoods 410 are dispersed in various geographic regions. Each of the cable access neighborhoods 410 is associated with a respective plurality of user devices 110. Referring to FIG. 4, a first cable access neighborhood 4101 is shown as serving a plurality of user devices 1101, 1102 and so on through 110N. The user devices 110 may comprise setup boxes, wireless networks or any other user device type capable of gaining access through the equipment within the cable access neighborhoods 410.

Each of the cable access neighborhoods 410 communicates with an access point 420 which provides access to a network 430. In various embodiments, the network 430 comprises a public IP network conveyed by any type of physical layer (optical, electrical, microwave and so on).

The network 430 communicates with a security gateway (SEG) 440 including a boundary device 442. The SEG 440 communicates with a secure network 450 within which is included expensive equipment associated with a television, video and/or VOD service provider. For example, FIG. 4 depicts the security Gateway 440 communicates with a head end 460 via a secured network 150. The head end 460 includes downlink mechanisms and the like associated with one or both of a satellite television transmission system 474 a terrestrial television transmission system 480.

The SEG 440 operates in a manner similar to that described above with respect to FIGS. 1-3. Within the context of the wholesale video service architecture depicted with respect to FIG. 4, the SEG 440 is located geographically proximate the head end 460 to reduce the expense associated with the secured network 450.

The wholesale video architecture of FIG. 4 operates to reduce the number of expensive equipment installations (such as cable television head-ends and the like) by providing secured network communications to one or more switches/routers (illustratively service routers) that service distant wholesale cable-television purchasers (e.g., small metropolitan system operators).

Specifically, the cable-television head-end receives broadcast video, broadcast television, video programming for local storage and so on from one or both of a terrestrial television transmitter and a satellite television transmitter.

The head end communicates with SEG 440 via a secured network, akin to the secure corporate network discussed above. This network includes firewalls and various other security components. The SEG 440 is illustratively located a short distance from the head end to reduce costs.

The SEG 440 communicates with each of a plurality (illustratively three) of cable-television endpoints 410, such as smaller wholesalers or even users/subscribers 110. The distance between the SEG 440, the access point and the cable-television endpoints point may be very large, may traverse one or more public networks and so on. Generally speaking, the specific transport layer infrastructure adapted to provide video services between the SEG 440 and cable-television endpoints may be public/non-secured.

To preserve content security, IPSec infrastructure is configured to provide one or more secure IPSec paths or sessions to support the cable-television endpoints. The provisioning and monitoring of the secure IPSec path is performed by network management software/hardware such as described above.

### Single Form Provisioning Embodiments

In various embodiments, the service provider provisions services for customers via operators interacting with one or more windows within a graphical user interface at a user terminal at, illustratively, a Network Operations Center (NOC). To efficiently provide such services, one embodiment contemplates a single form entry in which only a minimum amount of data associated with a secure network to be protected (i.e., identification of the secure network) is provided. Another embodiment contemplates an automatic provisioning of such services in response to a customer request in which the secure network to be protected is provided.

Thus, the various embodiments provide an ability to configure an IPSec system using a single configuration form, rather than multiple configuration forms associated with each of the multiple steps necessary to configure such a system. In this manner, the usual time-consuming interaction of network operations personnel is avoided, where each interaction is normally associated with a particular form for data entry (e.g., forms to select and provision the network equipment, links and so on, forms to provide groupings for redundancy function, forms to provide secure services, forms to configure encryption keys policies and so on).

In one embodiment, a NOC user invokes a method according to various embodiments at, illustratively, a computer terminal supporting a graphical user interface in which a secure IPSec establishment form is provided. This form accepts as input various criteria associated with a desired secure IPSec functionality.

First, a selection is made as to the network to be secured (e.g., a corporate network, intranet, Internet, single or multiple leased portions of a network and so on).

Second, a selection is made as to the specific entry or access point(s) to the selected network that will be used to support the desired secure IPSec functionality. These entry points may comprise, illustratively, a bridge (e.g., a router) between the network to be secured (e.g., the secure or corporate network of FIG. 1) and an access or core network (e.g., the non-secure or service provider network of FIG. 1). Alternatively, default access points may be used.

A corporation that wishes to use its secure corporate network within the context of remote workers may provide a service request including an access point for each worker or, more likely, an access point for each of N workers, where N is an integer greater than one but less than the total number of workers. There is generally no need to provide one access point for each remote user, unless it is necessary for all users to access the remote network at the same time.

The physical locations of the various access points are adapted to the likely location of the remote users. There is no benefit to allocating all access points to one physical location where remote users will be dispersed throughout a broad geographic region. In this case, those remote users in a geographically distant region will be forced to use one or more access networks just to get to the access point, which will certainly reduce the quality of experience and possibly increase the cost of their access of the secure company network via the secure IPSec infrastructure overlaid upon the non-secure public network. The secure IPSec tunnel supporting the worker will run through whatever networks are necessary to connect the worker to the boundary card.

Third, a selection is made as to the type of IPSec provisioning to be used, such as the public or private access points or access point types that will be capable of communicating with the bridging mechanism, as well as the protocols and so on supporting such communications. Alternatively, a default IPSec provisioning may be used.

The network selected for protection, as well as any access point, IPSec provisioning information or other information is then processed by a service creation engine to generate an IPSec infrastructure. The generated IPSec infrastructure may be optimized, validated in whole or in part, or otherwise refined before implementation.

### Service Creation Engine (SCE) Embodiments

One embodiment comprises a service creation engine (SCE) that creates an entire IPSec infrastructure/service layer in response to a service request including various profile information (e.g., selected secured network, network entry points and type the IPSec provisioning). The service creation engine examines the available cross-connects (public/private), configured for use in various IPSec tunnels or dynamic VPN tunnels adapted for the application, invokes the various provisioning algorithms and so on.

The service creation engine determines which services are to be secured and which nodes are needed to provide the desired access to the client or company. The IPSec infrastructure/service layer created by the service creation engine is optionally provided to a service provider for analysis, such as when one or more portions of the created IPSec layer traverse network equipment controlled by the service provider. The service provider analyzes the output of the service creation engine to identify the equipment necessary to satisfy the created IPSec infrastructure/service layer; such as requests to add, scale or otherwise update the requisite equipment, algorithms for encryption and key exchange, encryption keys and the like.

A tunnel template may include various signaling parameters that are employed to enable encryption/decryption of transport packets. Moreover, various rules/policies are employed to manage traffic flows, such as assigning IP addresses within a particular range to corresponding particular services, thereby mapping those IP addresses to particular services. Moreover, fractional use of IPSec tunnels may be employed to manage capacity reserved for the various services, such as bandwidth or switching capacity within a Service Gateway (SEG).

In various embodiments, customers provide service requests to the network provider including the various profile information associated with the secured service to be set up. The profile information is substantially as described above, and may include the identity of a corporate server to secure, the access points to be used with respect to secured service, the protocols to be used the encryption keys to use and so on.

In response, the service creation engine processes the service requests to automatically generate a secured IPSec infrastructure for use in satisfying the service request. Origins of the generated secured IPSec infrastructure may require further analysis by intermediate service providers to ensure that the assumptions associated with the generated infrastructure are appropriate. If they are not, service providers respond with suggestions (hopefully) or least an indication of which portions of the generated secured IPSec infrastructure are not workable.

In various embodiments, the SCE receives parameters (e.g., a profile) regarding desired IPSec services and responsively implements provisioning of the underlying communications channels (transport layer) and the layering of the appropriate IPSec infrastructure on the provision transport layer. This embodiment provides an automated or semi automated system in which a customer can provide a service request defining a network the customer wishes to provide access to (e.g., a secure corporate network or intranet) and the various parameters associated with that access, such as the number of remote users, the specific access points for users to access a network and so on. The SCE may be used in an autonomous mode to provide a provisioning plan in response to the received parameters.

The SCE may be used in an interactive mode within, e.g., a Network Operations Center user via a single-form entry screen (versus the multiple screens/forms presently used). The network manager software may interact with management software associated with intermediate network clouds to determine whether or not the IPSec infrastructure assumptions are appropriate for various parameters, such as other (e.g., third party owned) network clouds. Other permutations are also contemplated. Various embodiments comprise the SCE itself, the software utilized by the NOC user, methodologies including the interaction between the SEC, user, profile and/or third-party management software associated with other network clouds.

### IPSec Infrastructure Monitoring Embodiments

After the creation/provisioning of a secure IPSec infrastructure, another embodiment of the method enters a proactive monitoring mode of operation. In this embodiment, the various network elements and links associated with each path are known, such as within the context of the various communications or management systems (e.g., the Service Aware Manager Lucent (SAM) manufactured by Alcatel-Lucent for managing LTE systems).

Various of the management functions discussed herein may be used within the context of the embodiments to correlate the transport layer elements associated with each path and/or IPSec tunnel such that improved network management capabilities may be provided. In this manner, the degradation of service associated with a particular secured IPSec infrastructure path may be used to identify which of the network elements or links necessary to that path has it degraded. Similarly, the degradation of service associated with a particular network element or link may be used to identify which of the secured IPSec infrastructure paths correlated with the bad degraded network element or link might experience a problem.

In response to a failure (such as at an access point, link or network element), the encapsulating entity automatically correlates the failure to the secure IPSec path and/or one or more of the transmission layer elements supporting that path. The encapsulating entity and management function, a switch or router including the boundary card, a service aware manager (SAM) and the like. Further, an impact analysis is performed to determine which other secure IPSec path and/or transmission layer elements have failed or have been degraded.

Optionally, network probes or test vectors are executed to identify specific secure IPSec paths, mobile services, network elements, links and the like which may be degraded or failing. These tests measure network performance in real-time and elevate error conditions or other indications of network degradation before such degradation results in a larger problem or failure.

In various embodiments, the provisioned IPSec infrastructure is monitored to determine if any error conditions or other anomalies are detected indicative of potential service degradation or failure. This monitoring may be of a passive nature, in which error conditions, alarm conditions and the like are transmitted to the network management systems as they occur, in which an electric management system takes appropriate corrective action. This monitoring may be of an active nature, in which test vectors and/or other auditing mechanisms are utilized to test or exercise transport layer elements in an attempt to identify impending error conditions. For example, test vectors causing an increased bandwidth utilization may be used to stress the various components supporting one or more secure IPSec paths to determine whether or not an increase in bandwidth utilization will result in the degradation of service.

FIG. 5 depicts an exemplary management system suitable for use in the various embodiments. As depicted in FIG. 5, MS 500 includes a processor 510, a memory 520, a network interface 530N, and a user interface 530I. The processor 510 is coupled to each of the memory 520, the network interface 530N, and the user interface 530I.

The processor 510 is adapted to cooperate with the memory 520, the network interface 530N, the user interface 530I, and the support circuits 540 to provide various management functions for a network 130, such as the unsecured networks 130 discussed above with respect to the various figures.

The memory 520, generally speaking, stores data and tools that are adapted for use in providing various management functions for Network 130. The memory includes a Discovery Engine (DE) 521, a Discovery Database (DD) 522, a Correlation Engine (CE) 523, a Paths Database (PD) 524, an Analyzer Tool (ANT) 525, an Audit Tool (AUT) 526, a Trace Tool (TT) 527, a service creation engine (SCE) 528 and a service database (SD) 529. Optionally, a Fairness Management Tool (FMT) method be provided (not shown).

In one embodiment, the DE 521, CE 523, ANT 525, AUT 526, TT 527, SCE 528 and SD 529 are implemented using software instructions which may be executed by processor (e.g., processor 510) for performing the various management functions depicted and described herein.

The Discovery Database (DD) 522 and Paths Database (PD) 524 each store data which may be generated by and used by various ones and/or combinations of the engines and tools of memory 520. The DD 522 and PD 524 may be combined into a single database or may be implemented as respective databases. Either of the combined or respective databases may be implemented as single databases or multiple databases in any of the arrangements known to those skilled in the art.

Although depicted and described with respect to an embodiment in which each of the engines, databases, and tools is stored within memory 120, it will be appreciated by those skilled in the art that the engines, databases, and/or tools may be stored in one or more other storage devices internal to MS 500 and/or external to MS 500. The engines, databases, and/or tools may be distributed across any suitable numbers and/or types of storage devices internal and/or external to MS 500. The memory 520, including each of the engines, databases, and tools of memory 520, is described in additional detail herein.

The network interface 530N is adapted to facilitate communications with network 130. For example, network interface 530N is adapted to receive information from network 130 (e.g., discovery information adapted for use in determining the topology of the network, results of test initiated by MS 500 to network 130, and the like, as well as any other information which may be received by MS 500 from network 130 in support of the management functions performed by MS 500). Similarly, for example, network interface 530N is adapted to transmit information to network 130 (e.g., discovery requests for discovering information adapted for use by MS 500 in determining the topology of network, audit requests for auditing portions of Network 130, and the like, as well as any other information which may be transmitted by MS 500 to Network 130 in support of the management functions performed by MS 500).

The user interface 530I is adapted to facilitate communications with one or more user workstations (illustratively, user workstation 550), for enabling one or more users to perform management functions for Network 130. The communications include communications to user workstation 550 (e.g., for presenting imagery generated by MS 500) and communications from user workstation 550 (e.g., for receiving user interactions with information presented via user workstation 550). Although primarily depicted and described as a direct connection between MS 500 and user workstation 550, it will be appreciated that the connection between MS 500 and user workstation 550 may be provided using any suitable underlying communication capabilities, such that user workstation 550 may be located proximate to MS 500 (e.g., such as where both MS 500 and user workstation 550 are located within a Network Operations Center (NOC)) or remote from MS 500 (e.g., such as where communications between MS 500 and user workstation 550 may be transported over long distances).

Although primarily depicted and described herein with respect to one user workstation, it will be appreciated that MS 500 may communicate with any suitable number of user workstations, such that any number of users may perform management functions for Network 130 (e.g., such as where a team of technicians at a NOC access MS 500 via respective user workstations for performing various management functions for Network 130). Although primarily depicted and described with respect to user workstations, it will be appreciated that user interface 530I may be adapted to support communications with any other devices suitable for use in managing Network 130 via MS 500 (e.g., for displaying imagery generated by MS 500 on one or more common NOC display screens, for enabling remote Virtual Private Network (VPN) access to MS 500 by users via remote computers, and the like, as well as various combinations thereof). The use of user workstations to perform management functions via interaction with a management system will be understood by one skilled in the art.

As described herein, memory 520 includes a Discovery Engine (DE) 521, a Discovery Database (DD) 522, a Correlation Engine (CE) 523, a Paths Database (PD) 524, an Analyzer Tool (ANT) 525, an Audit Tool (AUT) 526, a Trace Tool (TT) 527, a service creation engine (SCE) 528, a service database (SP) 529 and, optionally, a Fairness Management Tool (FMT) method (not shown). DE 521, DD 522, CE 523, PD 524, ANT 525, AUT 526, TT 527, and FMT 528, which cooperate to provide the various management functions depicted and described herein. Although primarily depicted and described herein with respect to specific functions being performed by and/or using specific ones of the engines, databases, and/or tools of memory 520, it will be appreciated that any of the management functions depicted and described herein may be performed by and/or using any one or more of the engines, databases, and/or tools of memory 520.

The engines and tools may be activated in any suitable manner. In one embodiment, for example, the engines and tools may be activated in response to manual requests initiated by users via user workstations, in response to automated requests initiated by MS 500, and the like, as well as various combinations thereof.

For example, where an engine or tool is activated automatically, the engine or tool may be activated in response to scheduled requests, in response to requests initiated by MS 500 based on processing performed at MS 500 (e.g., such as where results generated by CE 523 indicate that ANT 525 should be invoked, such as where results of an audit performed by ANT 525 indicate that the TT 527 should be invoked, such as where results of a mobile session path trace performed by TT indicate that FMT 528 should be invoked, and the like, as well as combinations thereof). A description of the engines, databases, and tools of MS 500 follows.

In one embodiment, where an automatically triggered engine or tool begins to consume computing or other resources above a threshold level, subsequent automatic triggering of the engine or tool is constrained. In this embodiment, an alarm or status indicator is provided to the network manager indicative of the constrained automatic triggering condition such that the network manager or operating personnel may assume direct or manual control of the engine or tool.

### Generic Network Embodiments

The above-described embodiments operate to configure elements within an existing non-secure network environment to enable the services necessary to support secure tunneling between access points for users accessing a secure network via a non-secure network, such as Level 3 (L3) Virtual Private Networking (VPN) services, VPRN, IES and/or other services. When configured, the secure network (e.g., a corporate network) is protected with respect to users accessing the corporate network through non-secure networks such as the Internet (e.g., IPSec connections to corporate or other secure networks).

In a Secure Gateway (SEG) embodiment, a router associated with a boundary device operates as a secure client to a secure network, while various users operate as secure clients to the router. In this manner, IPSec traffic associated with the users is terminated at the boundary device of the Secure Gateway rather than at a termination point associated with the secure network. By avoiding the termination of multiple user IPSec tunnels within the secure network, the security of the network is enhanced, the provisioning complexity is reduced, and the corporate network may retain existing services and protocols (e.g., L2 VPN).

The various embodiments are operable within any of a plurality of network environments. Generally speaking, the various embodiments provide systems, apparatus, methodologies, functions, programs, topologies and so supporting a mechanism in which transport layer elements within a non-secure network are discovered, configured and correlated with paths supported by those transport layer elements such that various management functions including subsequent discovery and configuration functions may be more efficiently implemented.

### Detailed Examples Using an LTE Network Embodiment

Various embodiments will now be described within the context of an LTE network. In particular, the various management functions will be described in more detail with respect to LTE-related network environments, including network analysis functions, fault analysis functions, audit functions, tracing functions, fairness or bandwidth management functions and so on. It will be appreciated by those skilled in the art and informed by the present teachings that the systems, apparatus, methodologies, functions, programs, topologies and so on described herein with respect to LTE-related network environments are also applicable to other network environments, such as the various networks described above as well as other types of networks, systems, topologies and so on.

Correlation of Paths and Transport Layer Elements using LTE Example

Various embodiments utilize a known correlation between transport layer elements and the IPSec paths they support. Any of the various embodiments described herein with respect to IPSec may be combined in any manner with each other and with any of the various embodiments described below, such as providing IPSec related management functions, tools, methods, apparatus, systems data structures and so on in accordance with the descriptions herein.

A management capability is provided for managing a Fourth Generation (4G) Long Term Evolution (LTE) wireless network. The management capability may include one or more of an analyzer tool, an audit tool, a trace tool, an enforcement tool, and the like, as well as combinations thereof. Although primarily depicted and described herein within the context of providing management functions within a 4G LTE wireless network, it will be appreciated that the management functions depicted and described herein may be utilized within other types of wireless networks.

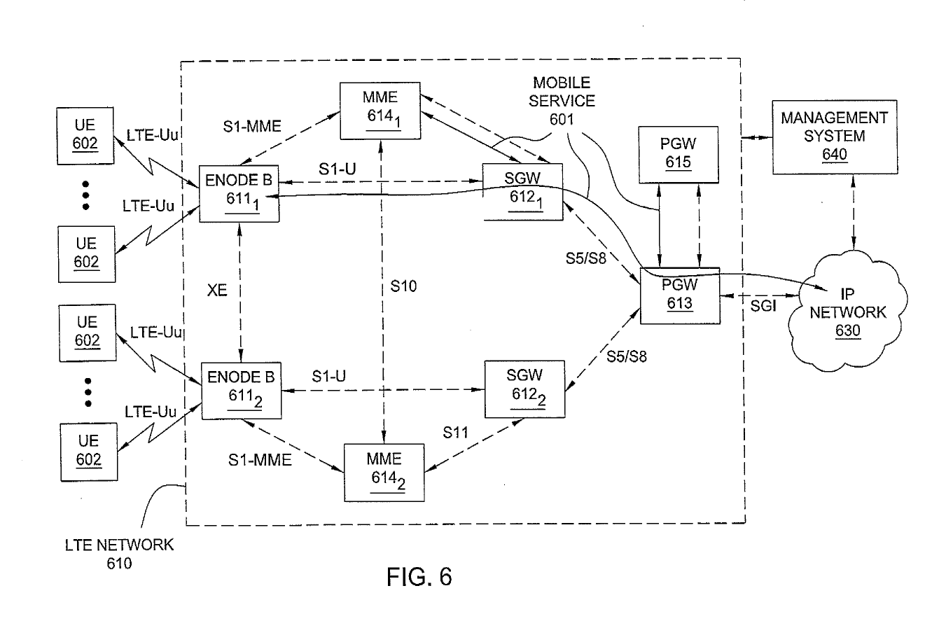

FIG. 6 depicts an exemplary wireless communication system including a management system according to an embodiment. Specifically, FIG. 6 depicts an exemplary wireless communication system 600 that includes a plurality of User Equipments (UEs) or User Devices (UDs) 602, a Long Term Evolution (LTE) network 610, IP networks 630, and a management system (MS) 640. The LTE network 610 supports communications between the UEs 602 and IP networks 630. The MS 640 is configured for supporting various management functions for LTE network 610 such as described with respect to the MS 500 of FIG. 5 and further as described herein.

The UEs 602 are wireless user devices capable of accessing a wireless network, such as LTE network 610. The UEs 602 are capable of supporting control signaling in support of the bearer session(s). The UEs 602 may be a phone, PDA, computer, or any other wireless user device.

The LTE network 610 is an exemplary LTE network. The configuration and operation of LTE networks will be understood by one skilled in the art. The exemplary LTE network 610 includes two eNodeBs 611₁ and 611₂ (collectively, eNodeBs 611), two Serving Gateways (SGWs) 612₁ and 612₂ (collectively, SGWs 612), a Packet Data Network (PDN) Gateway (PGW) 613, two Mobility Management Entities (MMEs) 614₁ and 614₂ (collectively, MMEs 614), and a Policy and Charging Rules Function (PCRF) 615. The eNodeBs 611 provide a radio access interface for UEs 602. The SGWs 612, PGW 613, MMEs 614, and PCRF 615, as well as other components which have been omitted for purposes of clarity, cooperate to provide an Evolved Packet Core (EPC) network supporting end-to-end service delivery using IP.

The eNodeBs 611 support communications for UEs 602. As depicted in FIG. 6, each eNodeB 611 supports a respective plurality of UEs 602. The communication between the eNodeBs 611 and the UEs 602 is supported using LTE-Uu interfaces associated with each of the UEs 602.

The SGWs 612 support communications for eNodeBs 611. As depicted in FIG. 6, SGW 612₁ supports communications for eNodeB 611₁ and SGW 612₂ supports communications for eNodeB 611₂. The communication between the SGWs 612 and the eNodeBs 611 is supported using respective S1-u interfaces. The S1-u interfaces support per-bearer user plane tunneling and inter-eNodeB path switching during handover.

The PGW 613 supports communications for the SGWs 612. The communication between PGW 613 and SGWs 612 is supported using respective S5/S8 interfaces. The S5 interfaces provide functions such as user plane tunneling and tunnel management for communications between PGW 613 and SGWs 612, SGW relocation due to UE mobility, and the like. The S8 interfaces, which are Public Land Mobile Network (PLMN) variants of the S5 interfaces, provide inter-PLMN interfaces providing user and control plane connectivity between the SGW in the Visitor PLMN (VPLMN) and the PGW in the Home PLMN (HPLMN). The PGW 613 facilitates communications between LTE network 610 and IP networks 630 via an SGi interface.

The MMEs 614 provide mobility management functions in support of mobility of UEs 602. The MMEs 614 support the eNodeBs 611. The MME 614₁ supports eNodeB 611₁ and the MME 614₂ supports eNodeB 611₂. The communication between MMEs 614 and eNodeBs 611 is supported using respective S1-MME interfaces, which provide control plane protocols for communication between the MMEs 614 and the eNodeBs 611.

The PCRF 615 provides dynamic management capabilities by which the service provider may manage rules related to services provided via LTE network 610 and rules related to charging for services provided via LTE network 610.

As depicted in FIG. 6, elements of LTE network 610 communicate via interfaces between the elements. The interfaces described with respect to LTE network 610 also may be referred to as sessions.

The LTE network 610 includes an Evolved Packet System/Solution (EPS). In one embodiment, the EPS includes EPS nodes (e.g., eNodeBs 611, SGWs 612, PGW 613, MMEs 614, and PCRF 615) and EPS-related interconnectivity (e.g., the S* interfaces, the G* interfaces, and the like). The EPS-related interfaces may be referred to herein as EPS-related paths.

The IP networks 630 include one or more packet data networks via which UEs 602 may access content, services, and the like.

The MS 640 provides management functions for managing the LTE network 610. The MS 640 may communicate with LTE network 610 in any suitable manner. In one embodiment, for example, MS 640 may communicate with LTE network 610 via a communication path 641 which does not traverse IP networks 630. In one embodiment, for example, MS 640 may communicate with LTE network 610 via a communication path 642 which is supported by IP networks 630. The communication paths 641 and 642 may be implemented using any suitable communications capabilities. An exemplary management system suitable for use as MS 640 of FIG. 6 is depicted and described with respect to FIG. 5.

FIG. 6 further depicts a path associated with an exemplary Mobile Service 601. As depicted in FIG. 6, the exemplary Mobile Service 601 includes eNodeB 1111, SGW 1121, PGW 113, the S1-u interface between eNodeB 1111 and SGW 1121, the S5/S8 interface between SGW 1121 and PGW 113, the SGi interface between PGW 113 and IP networks 130, the S1-MME interface between eNodeB 1111 and MME 1141, the S1-u interface between SGW 1121 and MME 1141, and the S7 interface between PGW 113 and PCRF 115. The exemplary Mobile Service 601 is marked on FIG. 6 using a solid line representation. Optional embodiments may include MME 1141 and PCRF 115, for example.

EPS-Path-IPSec Infrastructure Correlation

As previously noted with respect to FIG. 6, various embodiments of an LTE network 110 include an Evolved Packet System/Solution (EPS) infrastructure having EPS nodes (e.g., eNodeBs 111, SGWs 112, PGW 113, MMEs 114, and PCRF 115) and EPS-related interconnectivity (e.g., S* interfaces, the G* interfaces, and the like). Within the context of this present disclosure, the EPS-related interfaces are referred to herein as EPS-related paths or simply paths.

The infrastructure is architected to provide the appropriate and necessary EPS nodes for supporting the wireless services offered by the network service provider. The network service provider manages the network to provide its service offerings to its wireless/mobile users in a manner consistent with the consumer expectations. For example, wireless/mobile users (e.g., users of standard telephones, smart phones, computers and the like purchasing various voice, data or other service offerings) expect near perfect telephone/voice service, very near perfect data services, glitch-free streaming media and the like. Third party service providers purchasing service bundles for their own users expect the same, as well as management level interfaces and other mechanisms to provide interoperability between the various networks. Customer expectations may comprise an assumed or expected level of service, a level of service defined in a service level agreement (SLA) and the like.

Various embodiments are directed to network management systems and tools wherein each EPS-related interconnection is correlated to the specific infrastructure necessary to support that functionality. That is, for each EPS-related path, an association is made to the specific infrastructure necessary to support that path, including the network elements, sub-elements, links and so on which, if they fail or degrade, will result in failure or degradation of the associated EPS-related path.

By understanding which traffic flows or paths include an element, sub element or link as a necessary support element, the network management system can then know which traffic flows or paths are impacted by the degradation/failure of a specific element, sub element or link. Moreover, the network management system can then know which IPSec tunnels are impacted by the degradation/failure of specific traffic flows or paths. This is especially useful in the context of an analysis tool, as will be discussed in more detail elsewhere.

Similarly, by understanding which IPSec tunnel or traffic flow or path has failed or degraded, the network management system can then identify which elements, sub elements or links are necessary to support the IPSec tunnel or traffic flow or path. In this manner, the network manager reduces the complexity of identifying the element(s), sub-element(s) and/or link(s) that failed/degraded element or sub element associated with the IPSec tunnel or traffic flow or path that failed or degraded. This is especially useful in the context of a trace tool, as discussed in more detail herein.

Within the context of correlation, the management system may create a service representation for each connection between a network element or sub-element.

In various embodiments, a connection is provided between ports at either or both of the physical level (e.g., a cable or other physical level link) or the service level (e.g., a generalized cloud or other service level link).

In one physical level connection embodiment, if a port (or other sub-element) on a first network element (NE) fails, then a corresponding or connected port (or other sub-element) on a second NE will show a link down status (LLDP). In this manner, the second NE is aware of the failure of the first NE. In other physical level connection embodiment, such awareness is provided within the context of neighboring network elements, such as routers or switches and/or their various sub-elements.

In one service level embodiment, a port (or other sub-element) on a first NE may be connected directly to a port (or other sub-element) on a second NE, or through one or more ports (or other sub-elements) of one or more NEs (i.e., multiple hops between the first and second NEs). In this embodiment, if the port (or other sub-element) on the first or any intermediate NE fails or degrades, the management system may not be aware that the failure/degradation exists due to the operational status of the last NE in the sequence of NEs. However, due to the management techniques and tool discussed herein, the network manager is made aware of the initial or intermediate failure/degradation. Various causes of this behavior include congestion, local/regional rerouting and the like. In brief, status indicators are green (indicative of appropriate operation), but the performance of this portion of the network is constrained or degraded. This constrained or degraded network operation is correlated and illustrated by the various embodiments discussed herein.

Discovery Tool/Function

The discovery engine (DE) 521 is generally adapted for providing network discovery functions for discovering information about LTE network 110. Generally speaking, the DE 521 performs a discovery process in which configuration information, status/operating information and connection information regarding the elements and sub-elements forming the network is gathered, retrieved, inferred and/or generated as will be discussed in more detail below.

The discovery process may be dynamic in that the underlying elements, sub-elements and links within the LTE network may change over time due to local network adaptations, rerouting, failures, degradations, scheduled maintenance and the like. Thus, the DE 521 may be invoked after a network change is detected or caused by any of the ANT 525, AUT 526, TT 527, and FMT 528.

At a first discovery level, the network management system (NMS) uses any legacy database information to discover the various elements (and the corresponding sub-elements) forming the network to be managed. That is, some of this discovery comprises the use of existing database information which provides a general blueprint of the network to be managed. Information in such a database includes information associated with the major functional elements forming a network, the major pipes or conduits established within the network and so on. While such information may be extremely detailed, the information does not reflect path-level network operation.

At a second discovery level, the network management system requests configuration information, status/operating information and connection information from each of the network elements within the managed network. The requested information includes information useful in determining the specific switches, ports, buffers, protocols and the like within the network elements that support the various traffic flows.

The network management system may also utilize the existing database information to infer possible connections between network elements and sub-elements and connections within the network being managed. For example, the existing database information may be constructed as depicting a sequence of connected network elements that may support traffic flows between them. However, the existing database information likely does not include information identifying the specific switches, ports, buffers, protocols, address information of received/transmitted packets and the like within the network elements that support the various traffic flows.

Configuration information comprises information identifying a network element, the function and/or configuration of the network element, the function and/or configuration of the sub-elements forming a network element and so on. Configuration information illustratively includes, but is not limited to, information identifying the type of network element, protocols supported by the network element, services supported by the network element and so on. Configuration information illustratively includes information attending to the various sub-elements within the network element, such as the input ports, switches, buffers, and output ports and so on associated with the sub-elements forming a network element.

Status/operating information comprises status/operating information associated with the operating state of the network element and/or the sub-elements forming a network element. Status/operating information illustratively includes, but is not limited to, information providing operating status/alarm indicators, including information pertaining to metrics such as packet count, utilization level, component pass/fail indication, bit error rate (BER) and the like.

Connection information comprises information useful in ascertaining or inferring the connections between network elements and/or sub-elements, such as the source of data received from the network element or its sub-elements, the destination of data transmitted by the network element or its sub-elements and so on. That is, connection information is information provided by a network element from the subjective perspective of the network element. The network element does not necessarily have information specifically identifying the network elements from which it receives packets or the network element toward which it transmits packets.

Connection information illustratively includes, but is not limited to, source address information associated with received packets, destination address information associated with transmitted packets, protocol information associated with packet flows, service information associated with packet flows, deep packet inspection results data and the like.

At a third discovery level, the network management system uses the discovered information to form a detailed framework representing each of the elements, sub-elements and links forming the infrastructure of the network, as well as their respective and various interconnections.

Generally speaking, the DE 521 may discover any suitable information associated with LTE network 110, which may be referred to collectively herein as discovery information, and further divided into configuration information, status/operating information and connection information.

In various embodiments, DE 521 discovers components of the LTE network 110 and information associated with components of the LTE network 110, such network elements (EPC network elements, non-EPC network elements, and the like), sub-elements of network elements (e.g., chassis, traffic cards, control cards, interfaces, ports, processors, memory, and the like), communication links connecting network elements, interfaces/sessions that support communications between network elements (e.g., LTE-Uu sessions, S* sessions, and the like), reference points, functions, services, and the like, as well as combinations thereof.

DE 521 may discover the network elements of LTE network 110 (e.g., EPC network elements such as the eNodeBs 111, SGWs 112, PGW 113, MMEs 114, PCRF 115, and the like; non-EPC network elements that facilitate communication via sessions between the EPC network elements; and the like, as well as combinations thereof). DE 521 may discover network element configuration information associated with network elements of LTE network 110 (e.g., chassis configurations, line cards, ports on the line cards, processors, memory, and the like, which may depend on the types of network elements for which discovery is performed). DE 521 may discover interface/session information (e.g., information associated with LTE-Uu sessions, information associated with S* sessions, and the like, as well as combinations thereof). DE 521 may discover reference points of LTE network 110. DE 521 may discover functions, services, and the like, as well as combinations thereof. DE 521 may discover any other information that is associated with LTE network 110 and which is or may be suitable for use in providing the various management functions depicted and described herein.

The DE 521 may discover the information associated with LTE network 110 in any suitable manner (e.g., from any suitable sources, at any suitable times, using any suitable protocols, in any suitable formats, and the like, as well as combinations thereof).

The discovered information is stored in one or more databases to facilitate rapid retrieval by network operations personnel and/or other users, such as the Discovery Database (DD) 522. The DD 522 may store the discovery information in any suitable format, as will be understood by one skilled it the art. The DD 522 provides a repository of discovery information for use by CE 523 and, optionally, for use by one or more of ANT 525, AUT 526, TT 527, and FMT 528 for providing their respective management functions.

Correlation Engine Tool/Function

The Correlation Engine (CE) 523 provides correlation of information used to support the management functions depicted and described herein. The CE 523 utilizes configuration information, status/operations information and/or connections information, illustratively provided by the DE 521 and stored within the DD 522, to correlate discovered network element, sub-element and link functions to specific customer traffic flows and/or paths supporting customer services. That is, using the framework representing each of the elements, sub-elements and links within the network and their various interconnections, the CE 523 correlates each customer service, traffic flow and/or EPS-path to the specific elements, sub-elements and links necessary to support the customer service, traffic flow and/or path.

The correlation process may be dynamic in that, for any given path, the underlying elements, sub-elements and links supporting that path may change over time due to local network adaptations, rerouting, failures, degradations, scheduled maintenance and the like. Thus, CE 523 may be invoked after a network change is detected or caused by any of the ANT 525, AUT 526, TT 527, and FMT 528.

The CE 533 operates to maintain a current representation of the necessary supporting infrastructure associated with each customer service, traffic flow and/or path. By providing this representation, efforts responsive to customer service failure or degradation can be focused on the specific element, sub-element and link functions supporting the impacted customer service (e.g., by using Trace Tool (TT) 527). Similarly, efforts responsive to element, sub-element and link function failure or degradation can be focused on the specific customers and/or services supported by the impacted element, sub-element and link function.

Typically, only a small subset of the sub-elements within a particular element is necessary to support a particular path. Thus, a failure associated with other sub-elements within an element does not impact that particular path. By correlating to each path only those elements necessary to support the path, the processing/storage burdens associated with managing individual paths are reduced by avoiding processing/storage requirements associated with nonessential (from the perspective of a particular path) elements.

In one embodiment, CE 523 may process discovery information stored in Discovery Database (DD) 522 for purposes of determining the underlying transport elements supporting the paths of LTE network 110, which is then stored in Paths Database (PD) 524. In one embodiment, the path correlated transport element information determined by CE 523 and stored in PD 524 includes EPS-related paths of LTE network 110. In general, an EPS-related path is a path that is a transport mechanism that represents a peering relationship between two EPS reference points, where an EPS reference point is a termination point for any node of LTE network 110 that implements one or more of the protocols present in the 4G specification (e.g., using GTP, PMIP, or any other suitable protocols, and the like, as well as combinations thereof). The path correlated transport element information may comprise network elements, communications links, subnets, protocols, services, applications, layers and any portions thereof. These transport elements may be managed by the network management system or portions thereof. The network management system may simply be aware of these transport elements.

In one embodiment, the path correlated transport element information determined by CE 523 and stored in PD 524 includes other types of paths (e.g., paths other than EPS-related paths). For example, the other types of paths may include one or more of: (1) paths that form sub-portions of EPS-related paths (e.g., where an EPS-related path is supported using underlying communications technology, the path that forms a sub-portion of the EPS-related path may be a path associated with the underlying communications technology, (2) paths that include multiple EPS-related paths (e.g., paths from eNodeBs to PGWs that traverse both S1-u and S5/S8 sessions, paths from UEs to SGWs that traverse both LTE-Uu sessions and S1-u sessions, and the like), and (3) end-to-end mobile session paths (e.g., paths between UEs and IP networks). The path correlated transport element information determined by CE 523 and stored in PD 524 may include other information correlated with various types of paths.

The path correlated transport element information determined by the CE 523 and stored in the PD 524 may be determined using any suitable processing.

The CE 523 is adapted for making direct correlations between discovered components of LTE network 110.

The CE 523 is adapted for making inferences regarding associations between discovered components of LTE network 110.

In one embodiment, the network manager within which the CE 523 is operative includes substantially all of the information related to the peering of different EPS Paths (including S1-u). From that peering information, the CE 523 may identify nodes on each end of a path and then identify or examine the corresponding neighbor nodes. From the neighbor node information, the CE 523 may then identify or examine a next group of neighbor nodes and so on.

The correlation engine begins processing a path upon discovering that path from a managed network element. The correlation engine calculates, infers and/or otherwise discovers the various infrastructure elements, sub-elements and links supporting that path upon discovery of the path. In one embodiment, an initial S1-u reference point in the SGW is discovered. When any reference points or S-peer is discovered, a corresponding S-path is then formed.

The paths determined by the CE 523 may have any suitable path information associated therewith. In one embodiment, for example, path information associated with an EPS-related path may include any information indicative of the underlying communications capabilities supporting the EPS-related path. For example, the path information for an EPS-related path may include information identifying S* reference points forming the endpoints of the EPS-related path, identifying network elements supporting the path (e.g., routers, switches, and the like), identifying ports on the network elements that support the path, identifying IP interfaces supporting the path, specifying configurations of the IP interfaces supporting the path, specifying the configurations of the ports of network elements that support the path (e.g., administrative configurations, operational configurations, and the like), and the like, as well as combinations thereof.

In various embodiments, paths are grouped together in a logical structure according to a common element, sub-element, link, service, provider, third party service lessee and so on.

A bundle may be a logical grouping of paths that share a common element, such as a common end point element, start point element and the like. In this context, bundling is useful to identifying all of the paths that will be impacted by the failure of the common element. That is, a number of paths terminated at a particular network element from a plurality of other network elements of a common type may be defined as a bundle or group. Examples include “all of the eNodeB elements in communication with SGWx” where SGWx represents a specific SGW); or “all of the SGWs communicating with a PGWx” (where PGWx represents a specific PGW). These and other bundles or groups may be defined to enable rapid identification of network elements or sub-elements that are similarly situated in terms of a common network element or sub element to which they are connected.

The correlated information is stored in one or more databases to facilitate rapid retrieval by network operations personnel and/or other users, such as the Path Database (PD) 524. The PD 524 stores path correlated transport element information determined by CE 523. The PD 524 may store the path correlated transport element information and associated path information in any suitable format. The PD 524 provides a repository of path and network element related information for use by one or more of ANT 525, AUT 526, TT 527, and FMT 528 for providing their respective management functions.

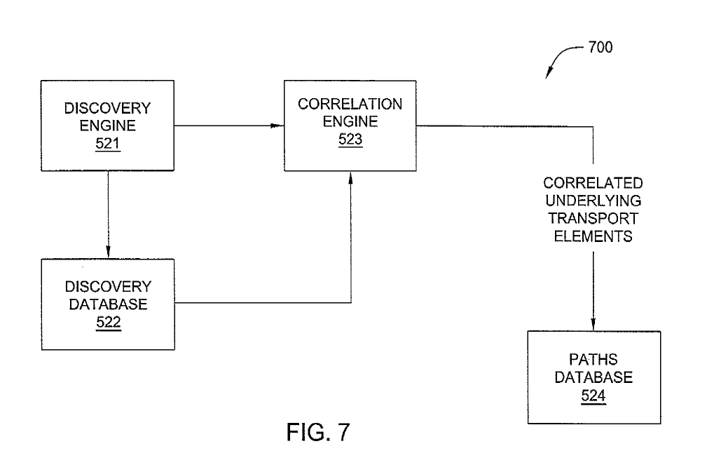

FIG. 7 depicts a high-level block diagram illustrating a discovery and correlation process performed by a management system according to one embodiment. As depicted in FIG. 7, and described herein with respect to the various figures, the discovery and correlation process 700 performed by exemplary MS 140 is performed by DE 521, DD 522, CE 523, and PD 524. The DE 521 discovers information associated with LIE network 110 and stores discovery information in DD 522, DE 521 and DD 522 provide discovery information to CE 523 for use by CE 523 in correlating the discovery information for identifying paths of the LTE network and storing the path correlated transport element information associated with the identified paths of the LTE network in the PD 524.

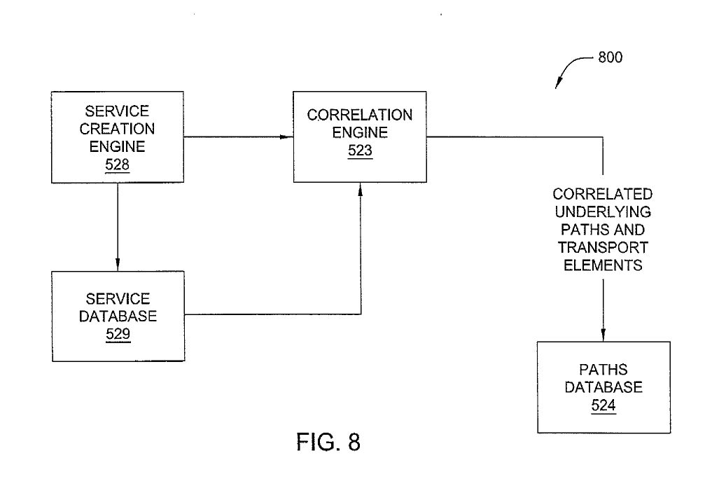

FIG. 8 depicts a high-level block diagram illustrating a discovery and correlation process performed by the exemplary management system suitable for use in various embodiments. As depicted in FIG. 8, and described with respect to the various figures, the service creation and correlation process 800 performed by exemplary MS 140 is performed by service creation engine 528, correlation engine 523, paths database 524 and service database 529.

The service creation engine 528 generates a service layer such as an IPSec service layer built upon various paths supported by the transport layer infrastructure of LTE network 110 and stores the service layer information in service database 529. The service creation engine 528 may also modify, update, validate or otherwise change the service layer, in which case the service layer information in service database 529 is also changed.

The service creation engine 528 and service database 529 provide service information to CE 523 for use by CE 523 in correlating the services to previously identified paths (and supporting transport layer elements) of the LTE network 110 and storing the service correlated path and, by extension, the transport element information associated with service correlated paths the LTE network 110 in the PD 524. The discovery and correlation process 800 of FIG. 8 may be better understood by way of reference to FIGS. 1-5 and the corresponding text.

The Analyzer Tool (ANT) 525 structures EPS elements of an LTE network into Mobile Services. In one embodiment, the EPS elements include the EPS network elements (e.g., eNodeBs, SGWs, PGWs, MMEs, the PCRF, and/or any other EPS-related network elements) and the EPS-related interconnectivity between the EPS network elements (e.g., S* sessions, G* sessions, and the like). For example, with respect to LTE network 110 of FIG. 1, the ANT 525 structures EPS elements of the LTE network 110 into Mobile Services (e.g., eNodeBs 111, SGWs 112, PGW 113, MMEs 114, PCRF 115, S* sessions, and the like). In this manner, a Mobile Service is a representation of EPS network elements and EPS-related interconnectivity between the EPS network elements.

The Mobile Service stores for each network element a list of all of the other network elements connected to it. Thus, for a particular eNodeB, the Mobile Service stores a list including the SGW and PGW to which the eNodeB communicates. Similarly, for a particular SGW, the mobile service stores a list including the eNodeBs and PGW to which the SGW communicates. Other common or anchor elements may be used to form such bundles. These examples contemplate, respectively, a particular eNodeB as an anchor or common element and a particular SGW as an anchor or common element. Other anchors or common elements may be defined within the context of the various embodiments.

The ANT 525 may structure EPS elements of LTE network 110 into Mobile Services using any suitable information (e.g., using the underlying transport elements correlated to EPS-related paths from PD 524, by processing discovery information from DD 522, and the like, as well as combinations thereof). In one embodiment, ANT 525 is configured to automatically create Mobile Services as areas of the LTE network 110 are discovered by DE 521.

Analyzer Function/Tool

The ANT 525 enables the service provider of an LTE network to have a current view of the status of the service delivery distribution network from the IP Core network through the eNodeB access nodes at the edge of the LTE network. The ANT 525 enables the service provider of an LTE network to monitor the status of the LTE network at a logical level. This is advantageous for efficiently diagnosing problems or potential problems which may impede delivery of mobile traffic within the LTE network. For example, equipment of the LTE network may be operational, but misconfiguration on an SGW instance might be blocking delivery of mobile traffic.

In various embodiments, other network parameters are monitored and subjected to processing by the various tools and techniques discussed herein. For example, in addition to monitoring each specific IPsec Tunnel, the IPsec Service to which a specific tunnel belongs may also be monitored. Additional monitoring may be provided wherever useful, such as monitoring the SEG, the Public+Private L3VPNs, the IPsec cards and groups, the interfaces and so on. The ANT 525 enables the service provider of an LTE network to quickly and easily identify which components of the LTE network 110 are responsible for problems or potential problems identified at the Mobile Service level of LTE network 110, e.g., by identifying which EPS element(s) are responsible for the problem or potential problem, and then further identifying which component(s) of the responsible EPS element(s) are responsible for the problem or potential problem.

For example, this may include identifying, at the IPSec tunnel or Mobile Service level, a specific EPS network element that is responsible for the problem, and then drilling down on the EPS network element that is responsible for the problem to identify components of the EPS network element that are responsible for the problem. The components of EPS network elements may include any components of the EPS network elements (e.g., traffic cards, control cards, ports, interfaces, processors, memory, and the like).

The ANT 525 may drill down on EPS elements in any suitable manner, which may depend on the type of EPS element for which component information is desired (e.g., using discovery information stored in DD 522 for determining components of EPS network elements, using the path correlated transport elements, sub-elements, systems and other information stored in PD 524 for determining components of EPS-related paths, and the like, as well as combinations thereof). The ANT 525 may perform one or more management functions for IPSec tunnels or Mobile Services determined by ANT 525.

In one embodiment, ANT 525 may collect statistics associated with IPSec tunnels or Mobile Services (e.g., end-to-end statistics associated with the IPSec tunnel or Mobile Service, statistics associated with individual components and/or subsets of components of the IPSec tunnel or Mobile Service, and the like, as well as combinations thereof). The ANT 525 may analyze collected statistics for identifying the presence of congestion, or impending presence of congestion, associated with IPSec tunnels or Mobile Services. The ANT 525 may proactively determine, on the basis of such analysis, solutions for resolving or preventing congestion.

In one embodiment, ANT 525 may initiate audits for verifying IPSec tunnels or Mobile Services (e.g., for ensuring that the view of IPSec tunnels or Mobile Services currently maintained by ANT 525 is accurate and does not need to be updated, for use in updating the view of IPSec tunnels or Mobile Services where such updating is required, and the like, as well as combinations thereof).

In one embodiment, ANT 525 may initiate Operations, Administration, and Maintenance (OAM) tests for IPSec tunnels or Mobile Services.

In one embodiment, ANT 525 may perform fault analysis for IPSec tunnels or Mobile Services. The ANT 525 may categorize detected events based on their importance.

In one embodiment, ANT 525 may initiate generation of imagery adapted for being displayed to provide network technicians of the service provider with a visual representation of the event (e.g., location of the event, scope of the event, and the like).

In one embodiment, ANT 525 may initiate one or more OAM tests (e.g., ping, traceroute, and the like) for the Mobile Service(s) associated with the event, in order to determine additional information providing a better understanding of the scope and impact of the event.

The ANT 525 may perform any other suitable management functions associated with IPSec tunnels or Mobile Services determined by ANT 525.

Generally speaking, the analyzer tool may be invoked after the network manager discovers the network elements and their connections as previously described. The service aware manager identifies the LTE type network elements, such as PGW, SGW, eNodeB, MME, PCRF, SGSN and the like. Of primary interest are the PGW, SGW and eNodeB. Between these network elements are EPS paths having associated reference points on the network elements, where the EPS paths/reference points are denoted as S1-u, S5, SGi and so on. Thus, stored in a database is a collection of modular components, of type “network element” for the PGW, SGW, eNodeB and the like, or type “connector” for the EPS paths.

After discovering the network elements and connectors, the service aware manager defines a plurality of IPSec tunnels or Mobile Services by connecting or concatenating instances of the two types of modular components (i.e., network elements and connectors), such as the sequence of network elements and connectors between a customer served via a specific eNodeB and a data stream or other service received from the IP core network at the PGW. Thus, in one embodiment, a mobile service comprises a structure or wrapper containing a concatenated sequence of network elements and connectors. A Mobile Service may be defined in terms of a particular customer, a particular eNodeB, a particular APN and so on. A mobile service may include one or more instances of an EPS on a network element, such as one or more of an SGW or a PGW on a single or common network element.

After defining the IPSec tunnels and/or Mobile Services, the IPSec tunnels or Mobile Services may be analyzed or tested. Such testing may be directed to the components forming a Mobile Service, the endpoints associated with the Mobile Service and the like. Such testing may be directed to specific portions of specific components or endpoint forming the Mobile Service.

In one embodiment, individual IPSec tunnels or Mobile Services or groups of IPSec tunnels or Mobile Services are analyzed by collecting statistics from each of the Mobile Service modular components forming the particular individual or groups of IPSec tunnels or Mobile Services. That is, a Mobile Service analysis request (generated manually or automatically) is interpreted by the management system as a request to gather statistical information pertaining to each of the modular components (e.g., network elements and connectors) forming a Mobile Service.

Thus, the logical representation of modular components such as “network element” and “connector” to form IPSec tunnels or Mobile Services enables precise auditing, analysis and tracing functions to be implemented within the context of the various embodiments.

Auditor Function/Tool

The Audit Tool (AUT) 526 is configured to provide an audit capability for auditing a network. The AUT 526 enables proactive auditing of network infrastructure of a network for identifying and handling network faults or potential network faults that are impeding or may impede end user traffic. The AUT 526 supports quick detection of network faults or potential network faults, impact analysis for determining the impact of faults or potential impact of potential network faults, and rectification of any network faults or potential network faults.

The AUT 526 provides an ability to perform in-depth network health or sanity checks on LTE network 110 at any granularity level, e.g., for checking the health of ports, line cards, physical connectivity, logical connectivity, S* reference points, S* sessions, network paths, end-to-end mobile sessions of end users, and the like, as well as combinations thereof. The AUT 526 provides significant advantages in managing LTE networks, as such networks are inherently complex and, thus, highly susceptible to network faults that are often difficult to correlate to mobile subscriber data that has been packetized for transport over an IP network traversing multiple network elements that utilize different transport technologies and applied QoS policies.

In one embodiment, AUT 526 supports auditing of interconnectivity within LTE network 110. The auditing of interconnectivity may include proactively monitoring for connectivity, testing connectivity, and performing like auditing functions.

Tracer Function/Tool

The Trace Tool (TT) 527 is configured to provide a mobile session trace capability. The mobile session trace capability enables a path of a mobile session of a UE to be traced through a wireless network. Briefly, the TT 527 enables a determination of the path of a IPSec tunnel or mobile session through a wireless network and, optionally, determination of additional information associated with the mobile session. The IPSec tunnel mobile session trace capability enables wireless service providers to perform management functions based on the determined path of the IPSec tunnel or mobile session through the wireless network.

Fairness Manager Function/Tool

The Fairness Manager Tool (FMT) 528 provides various fairness management mechanisms adapted to controlling usage of network resources by mobile subscribers. Briefly, the FMT 528 enforces appropriate resource (e.g., bandwidth) usage by customers, such as defined by service level agreements (SLAs) and the like. The fairness manager enforces appropriate bandwidth usage by any of a variety of enforcement mechanisms. The fairness manager is operative to enforce appropriate resource consumption levels associated with various users, groups of users, customers, third party network purchasers and the like, whether those levels are defined by agreement or acceptable practice.

Examples of Environment Supporting the Various Embodiments

Generally speaking, various embodiments enable a user to interact with the management system/software and thereby to “drill down” deeper from upper to lower hierarchical level path elements by displaying lower level path elements associated with upper level path elements selected by a user via a user interface. The user may be a user in a network operations center (NOC) utilizing a computer terminal or other user workstation with a graphical user interface (GUI)

In one embodiment, mobile session path information is displayed by generating a “sub-map” including only the network components that support the mobile session and displaying the generated sub-map. For example, where the graphical display of the wireless network includes many eNodeBs, SGWs, and PGWs, the sub-map for a mobile session will include only one of each of those elements, as well as the sessions between each of those elements, thereby highlighting which network elements of the wireless network are supporting the mobile session.

In this example, the sub-map may be displayed in any suitable manner (e.g., simultaneously in a window in a different portion of a window in which the wireless network is displayed, in a new window opened for purposes of displaying the sub-map, and the like). In this example, as in the previous example, the mobile session path, or even components and sub-components of the mobile session path (e.g., physical equipment, physical communication links, sub-channels on physical communication links, and the like), may be selectable such that, when selected by the user, the user is presented with additional mobile session path information associated with the mobile session.

From such examples, it will be appreciated that display of additional information associated with a mobile session path may be provided in any suitable manner (e.g., refreshing within the display window to include mobile session path information, opening a new window including mobile session path information, and the like, as well as combinations thereof).

Implementations of the various methods optionally yield logical and/or physical representations of one or more paths, underlying transport elements supporting the one or more paths, as wells as various protocols, hardware, software, firmware, domains, subnets, network element and/or sub-element connections as discussed herein. Any of these physical and/or logical representations may be visually represented within the context of a graphical user interface (GUI). Moreover, the various interactions and correspondences between these physical and/or logical representations may also be visually represented, included representations limited to specific criteria, such as those representations “necessary to support a path”, “necessary to support a client/customer”, “associated with a single client/customer” and so on. Such graphical representations and associated imagery provide infrastructure views (i.e., from the perspective of one or more transport elements) or services views (i.e., from the perspective of one or more services) of the network in either a static or dynamic manner.

A computer suitable for use in performing the functions described herein may include, illustratively, a processor element (e.g., a central processing unit (CPU) and/or other suitable processor(s)), a memory (e.g., random access memory (RAM), read only memory (ROM), and the like), a management module/processor, and various input/output devices (e.g., a user input device (such as a keyboard, a keypad, a mouse, and the like), a user output device (such as a display, a speaker, and the like), an input port, an output port, a receiver/transmitter (e.g., network connection or other suitable type of receiver/transmitter), and storage devices (e.g., a hard disk drive, a compact disk drive, an optical disk drive, and the like)). In one embodiment, computer software code associated with methods for invoking the various embodiments can be loaded into the memory and executed by processor to implement the functions as discussed herein above. The computer software code associated with methods for invoking the various embodiments can be stored on a computer readable storage medium, e.g., RAM memory, magnetic or optical drive or diskette, and the like.

It should be noted that functions depicted and described herein may be implemented in software and/or in a combination of software and hardware, e.g., using a general purpose computer, one or more application specific integrated circuits (ASIC), and/or any other hardware equivalents.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible fixed or removable media, transmitted via a data stream in a tangible or intangible broadcast or other signal bearing medium, and/or stored within a memory within a computing device operating according to the instructions.

Although primarily depicted and described herein with respect to embodiments in which the management capability is used for managing an LTE wireless network, it will be appreciated that the management capability may be used for managing other types of wireless networks, including, but not limited to, other types of 4G wireless networks, 3G wireless networks, 2.5G wireless networks, 2G wireless networks, and the like, as well as combinations thereof.

Various methods for provisioning an IPSec network upon non-secured network infrastructure are disclosed, wherein the non-secured network infrastructure may comprise a plurality of network elements and communications links adapted to support a plurality of services, the method may comprise identifying one or more switching devices in secure communication with a secure network; retrieving configuration information associated with the identified switching devices; determining transport layer elements within the non-secured network infrastructure necessary to support the IPSec network; and adapting the operation of the identified necessary transport layer elements to the IPSec network such that secure communication is provided between the IPSec network and the secure network. The identifying one or more switching devices may be provided via an entry form in a network operations center (NOC). The transport layer elements of the non-secured network infrastructure necessary to support the IPSec network may be identified using data correlating transport layer elements and mobile services. The data correlating transport layer elements and mobile services is discovered according to various techniques described herein.

Although various embodiments which incorporate the teachings of the present invention have been shown and described in detail herein, those skilled in the art can readily devise many other varied embodiments that still incorporate these teachings.

What is claimed is:

1. A method for generating an secure service layer upon non-secured network infrastructure, comprising:
receiving a service request associated with a desired IPSec service, the service request information including at least an identification of a secure network to be protected;
selecting at least one routing device including a boundary device for use as a Secure Gateway (SEG);
providing a secure networking service to terminate secure traffic from the secure network at a first portion of the boundary device;
providing a secure networking service to terminate tunneled public traffic from a non-secure network at a second portion of the boundary device;
creating an interface to appropriately group tunneled traffic and corresponding secure traffic to form secure network traffic paths, wherein each group is associated with a respective encapsulation identifier.

2. The method of claim 1, further comprising:
selecting one or more access points within the non-secure network authorized to access the secure network.

3. The method of claim 2, wherein multiple access points within the non-secure network are authorized to access the secure network, the method further comprising:
associating each of the access points with an appropriate SEG; and
configuring the secure networking service of each SEG to terminate tunneled public traffic from corresponding access points.

4. The method of claim 1, wherein said secure networking service to terminate secure traffic from the secure network comprises a Level 3 Virtual Private Network (L3 VPN) service.

5. The method of claim 1, wherein said secure networking service to terminate tunneled traffic from the non-secure network comprises one of a Level 3 Virtual Private Network (L3 VPN) service, a VPRN (Virtual Private Routed Network) service and a IES (Internet Enhanced Service) service.

6. The method of claim 1, wherein said secure networking service to terminate secure traffic from the secure network enables communication between a terminated IPSec tunnel and a Level 2 (L2) VPN secure network.

7. The method of claim 1, wherein said secure service layer comprises an IPSec infrastructure and said tunneled public traffic comprises IPSec tunneled traffic.

8. The method of claim 1, wherein said selecting of said at least one routing device including a boundary device comprises:
identifying one or more routers proximate the secure network to be protected; and
selecting one of said routers according one or more of the following criteria: cost, proximity to customer, proximity to service provider and utilization level.

9. The method of claim 1, wherein said generated IPSec service layer comprises a service for securely connecting a plurality of users to said secured network, said method further comprising further comprising:
dividing said users into a plurality of groups; and
directing traffic associated with each group to a respective access point.

10. The method of claim 9, wherein said user groups are defined according to user location.

11. The method of claim 10, further comprising aggregating traffic associated with a group of users at a switching element geographically proximate the group of users.

12. The method of claim 11, wherein said aggregated traffic includes video services traffic, said aggregated traffic communicated between said geographically proximate switching element and a head-end of a video services provider.

13. The method of claim 12, wherein said video services provider comprises one of a cable television system, a MSO, a telecommunications systems provider and a broadcast network.

14. The method of claim 1, wherein said method is executed by a service creation engine (SCE) instantiated within a computer associated with a network service provider.

15. The method of claim 1, wherein said method is executed by a service creation engine (SCE) instantiated within a network operations center (NOC) of a network service provider.

16. The method of claim 14, wherein said request includes configuration information associated with a type of secure connection to be made through one or more identified access points.

17. The method of claim 14, wherein the type of secure connection comprises an IPSec tunnel.

18. The method of claim 14, wherein the secured network comprises at least one of a secure corporate network, a secure intranet, one or more portions of a single third party network, and one or more portions of multiple third party networks.

19. The method of claim 14, wherein the request further includes identifying information associated with one or more access points in secure communication with the secured network.

20. The method of claim 19, wherein each of said access points comprises at least one of a switching device, a router and a bridge between said secured network and said non-secured network.

21. The method of claim 20, wherein said non-secured network comprises one of a core network and an access network.

22. The method of claim 19, wherein said access point comprises a router including an IPSec boundary device operative to terminate IPSec traffic from said generated IPSec service layer at said secured network.

23. The method of claim 19, wherein:
said generated IPSec layer supports secure traffic from between users accessing said non-secure network by routing traffic from each user to respective access points of said secured network via respective IPSec tunnels; and
for users having different access points to said secured network, traffic between said users is routed between said different access points via said secured network; and
for users having a common access point to said secured network, traffic between said users is routed directly through said common access point.

24. The method of claim 1, further comprising adapting the operation of one or more mobile services to according to said generated IPSec service layer to provision thereby the desired IPSec service.

25. The method of claim 1, further comprising adapting the operation of one or more transport layer elements supporting paths associated with mobile services included within said generated IPSec service layer.

26. The method of claim 1, wherein the service request is provided via data entered into a single form at a network operations center (NOC).

27. The method of claim 26, wherein the service request is provided via data included within a single form by a customer, the method further comprising reviewing the service request to validate conformance with a service level agreement (SLA) associated with the customer.

28. The method of claim 1, wherein said request is associated with a tunnel template including signaling parameters associated with tunneled traffic flow.

29. The method of claim 28, wherein said tunnel template further includes policies related to tunneled traffic flow.

30. The method of claim 29, wherein said policies include one or more of an associated between particular IP addresses and corresponding services.

31. The method of claim 29, wherein said policies provide for fractional use of IPSec tunnels.

32. The method of claim 1, further comprising:
determining whether any portions of mobile services within the generated IPSec service traverse a non-managed network; and
forwarding, toward a manager of said non-managed network, a request to validate the generated IPSec service conveyed via mobile service portions associated with said non-managed network.

33. The method of claim 1, further comprising forwarding, toward a manager of a non-managed network, a request to validate support for one or more mobile service portions within said generated IPSec service that traverse said non-managed network.

34. The method of claim 33, further comprising:
in response to a message indicative of a lack of support by said non-managed network for a mobile service portion, forwarding toward said manager of said non-managed network a request to adapt a provisioning of said mobile service portion to provide support for said mobile service portion.

35. The method of claim 1, wherein data correlating each path to its respective transport layer infrastructure is stored in a database initially generated during a discovery process.

36. The method of claim 6, wherein said database is generated according to the steps of iteratively correlating path structure associated with underlying transport layer structure and storing the results of this correlation.

37. The method of claim 1, wherein the non-secure network comprises an LTE network, the method further comprising:
identifying IES and VPRN services associated with the one or more identified access points, each mobile service comprising at least one path, each path supported by transport layer infrastructure within said non-secured network; and
generating an IPSec service layer using one or more of said mobile services.

38. A computer readable medium including software instructions which, when executed by a processor, perform a method for generating a secure service layer upon non-secured network infrastructure, comprising:
receiving a service request associated with a desired IPSec service, the service request information including at least an identification of a secure network to be protected;
selecting at least one routing device including a boundary device for use as a Secure Gateway (SEG);
providing a secure networking service to terminate secure traffic from the secure network at a first portion of the boundary device;
providing a secure networking service to terminate tunneled public traffic from a non-secure network at a second portion of the boundary device;
creating an interface to appropriately group tunneled traffic and corresponding terminated secure traffic to form secure network traffic paths, wherein each group is associated with a respective encapsulation identifier.

39. A computer program product, wherein a computer is operative to process software instructions which adapt the operation of the computer such that computer performs perform a method for generating a secure service layer upon non-secured network infrastructure, comprising:
receiving a service request associated with a desired IPSec service, the service request information including at least an identification of a secure network to be protected;
selecting at least one routing device including a boundary device for use as a Secure Gateway (SEG);
providing a secure networking service to terminate secure traffic from the secure network at a first portion of the boundary device;
providing a secure networking service to terminate tunneled public traffic from a non-secure network at a second portion of the boundary device;
creating an interface to appropriately group tunneled traffic and corresponding secure traffic to form secure network traffic paths, wherein each group is associated with a respective encapsulation identifier.

40. A Secure Gateway (SEG), comprising:
a first plurality of ports accepting traffic associated with a non-secure network;
a second plurality of ports accepting traffic associated with a secure network; and
a boundary device adapted to provide a secure networking service to terminate secure traffic from the secure network at a first portion, adapted to a secure networking service to terminate tunneled public traffic from the non-secure network at a second portion, and adapted to create an interface to appropriately group tunneled traffic and corresponding secure traffic to form secure network traffic paths, wherein each group is associated with a respective encapsulation identifier.
